(19) United States
(12) Patent Application Publication
(10) Pub. No.: US 2009/0199631 A1
(43) Pub. Date: Aug. 13, 2009

(54) Textile Machine Producing Cross-Wound Bobbins

(75) Inventor: Paul Straaten, Schwalmtal (DE)

Correspondence Address: K&L Gates LLP, 214 N. TRYON STREET, HEARST TOWER, 47TH FLOOR, CHARLOTTE, NC, 28202, US

(73) Assignee: OERLIKON TEXTILE GMBH & CO. KG, MONCHENGLADBACH (DE)

(21) Appl. No.: 11/922,744

(22) PCT Filed: Apr. 19, 2006
(86) PCT No.: PCT/EP2006/003548

§ 371 Date: Dec. 21, 2007

(30) Foreign Application Priority Data
Jun. 28, 2005 (DE) 10 2005 029 935.0

(51) Int. Cl. G01L 5/04

(52) U.S. Cl. 73/160

(57) ABSTRACT

This invention relates to a textile machine that produces cross-wound bobbins, comprising a device, which is arranged on an operating unit and which serves to test the quality of a yarn or yarn piecings produced at one of the spinning locations of the textile machine. The operating unit has a tensile testing device as well as a device for transferring a yarn to the tensile testing device. The invention provides that the tensile testing device (15) has a measuring section (19) of a predetermined length. Yarn clamps (20, 21) are placed at the end of the measuring section (19). The first yarn clamps (20) is displaceably mounted and can be acted upon in a defined manner by a drive (22). A sensor device (23) is placed in the area of the measuring section (19). Both the drive (22) as well as the sensor device (23) are connected to a control device (25).

The invention relates to a textile machine producing cross-wound bobbins according to the preamble of claim 1.

It has been known for a long time in conjunction with textile machines producing cross-wound bobbins to monitor a running thread for thread defects. The yarn monitoring which was possible up to now directly during the production process was limited, however, to optical or capacitive analysis possibilities (thick locations, thin locations, burls, hairiness, diameter, extraneous fibres etc.). Other important diameters, such as tear resistance of the thread, thread elongation, thread fineness, thread rotation etc. have generally been monitored up to now in the laboratory. Monitoring mostly took place in this case at the start of the batch and later at irregular time intervals. For monitoring, bobbins firstly had to be removed from the winding devices of the textile machine, checked and optionally returned to the textile machine later. Because of this relatively laborious method, the quantity of the spot checks was generally limited. In other words, in the method which was conventional up to now, a relatively large unusable quantity of yarn could already have occurred by the time inadmissible deviations were established (for example owing to the confusion of spinning cans, band fineness defects of the section, wear or faulty adjustment at the spinning stations/winding heads). An important criterion for the quality of a cross-wound bobbin is moreover the tensile strength of the piecers. The tensile strength of the piecers was also relatively laboriously determined in the laboratory up until now.

A method is known from DE 37 05 925 A1, in which yarn produced on open end friction spinning devices can be checked by a maintenance apparatus for its minimum tear resistance and a tendency to cockling and on falling below or exceeding predetermined yarn values, certain adjustment parameters of the open end friction spinning devices are adapted. The described method is imprecise, however, and not suitable for exact determination of the yarn parameters described above.

A method and a device for investigating the yarn quality at the spinning stations of a textile machine producing cross-wound bobbins is also described in DE 198 41 604 A1. By means of an automatic travelling machine, in this case, a thread is drawn off from a cross-wound bobbin, which is held in the creel of a workstation of a textile machine producing cross-wound bobbins and repeatedly subjected to a tearing test. The known device in this case has a thread retaining device, a thread tensioning device and a measuring head. In other words, a thread strand tensioned, for example, between the braked cross-wound bobbin and the thread suction nozzle of the automatic travelling mechanism is drawn over a measuring head, the thread tension detected and indicated in an associated display device. At the moment of tearing of the thread, the thread tension abruptly jumps back to zero. The size of the thread tension determined in this manner is in a proportional relationship here to the tear resistance of the thread. The investigation results which can be achieved by this known device are also very imprecise. In other words, investigation results, which were determined with this known device have shown clear spreads and imprecisions during comparisons with investigation results, which were achieved with laboratory apparatuses. The known device was therefore not successful in practice.

Proceeding from textile machines producing cross-wound bobbins of the type described above, the invention is based on the object of providing a mechanism, which allows yarn strength tests to be carried out directly at the winding head of the textile machine, with the test conditions substantially corresponding to the valid norms and standards of laboratory test apparatuses.

This object is achieved according to the invention by a mechanism, as described in claim 1.

Advantageous configurations of the invention are the subject of the sub-claims.

The use of an operating unit configured according to the invention with a tensile testing device, which has a measuring section of predetermined length with thread clamps arranged at the end of the measuring section, wherein at least one of the thread clamps is movably mounted and can be acted upon by a drive, as well as a sensor device arranged in the region of the measuring section, which is connected, like the drive for displacing the thread clamp, to a control device, above all has the advantage that a better safeguarding of the yarn quality can be achieved in a simple manner, for example by increasing the testing frequency without additional transportation, handling or laboratory costs for the yarn strength test accruing. With the device according to the invention, not only can the tear resistance of the thread and the maximum thread elongation be determined without problems but the piecers can also be checked with regard to their strength.

As described in claim 2, the drive for the movably mounted thread clamp is preferably configured as a stepping motor. A stepping motor of this type is a proven economical mass production part, which can be precisely controlled in a relatively simple manner.

In an alternative embodiment, to displace one of the two thread clamps, a pneumatic thrust piston gear may also be used, however, instead of a stepping motor (claim 3).

As shown in claims 4 and 5, the sensor device arranged in the region of the measuring section is either a measured value detector corresponding to one of the thread clamps or a thread tensile force sensor positioned between the thread clamps. A measured value detector corresponding with the second thread clamp, for example, in this case directly measures the axial thread tensile force, while a thread tensile force sensor arranged between the thread clamps measures a force component, which acts orthogonally to the tension direction of the thread.

According to claims 6 and 7, a first thread clamp is either movably mounted via a pivot lever or the thread clamp is displaceably mounted in a linear guide. The movable mounting of a thread clamp to a pivot lever has the advantage here that such an arrangement can be implemented very easily and therefore economically with regards to its structural configuration.

As described in claim 8, it is provided in an advantageous embodiment that the first thread clamp, which is arranged on a pivot lever, can be displaced in a defined manner by an electric motor drive configured as a stepping motor. In other words, the stepping motor pivots the first thread clamp fixed to the pivot lever, which clamp secures the thread, which is also held in the second thread clamp, until the thread breaks. By adding the number of motor steps, which the stepping motor carries out from reaching a prestressing force until a maximum tensile force is reached and by multiplication with a corresponding conversion formula, the maximum tensile force elongation of the thread can be determined easily and very precisely. The measuring results, which can be achieved with a tensile testing device configured in this manner are comparable, in this case, with measuring results such as are determined in a textile laboratory.

As shown in claim 9, it is also provided in an advantageous configuration that for the exact determination of the zero position of the pivot lever, an initiator is provided. An initiator of this type is preferably a Hall sensor (claim 10). A proven Hall sensor of this type is a reliably means allowing the zero position of the pivot lever to be precisely approached and to be reproducible as often as desired.

In an alternative embodiment, instead of an initiator, a fixed stop may also, however, be installed, as described in claim 11. A fixed stop is also a suitable device for reliably fixing a zero or starting position.

As shown in claim 12, the second thread clamp is fixed via a force sensor to a housing wall of the operating unit, the force sensor being configured as a strain gauge force detector in a preferred embodiment (claim 13). Force detectors of this type which have strain gauges and which are known per se and consist substantially of a carrier, on which an electric resistor, for example an etched foil, is applied, operate very precisely. Each length change of the carrier, which in the present case is triggered by the thread tensile force of the thread held in the first thread clamp, immediately leads to a proportional resistance change, which is processed in an associated measured value amplifier. Strain gauge force detectors of this type are economical, very precise measuring devices, which operate very reliably.

Advantageous, alternative embodiments for the arrangement of the second thread clamp and the separate arrangement of the associated measured value detectors are described in claims 14 and 15.

In other words, according to claim 14, the measured value detector, the force sensor of which is supported in a damping means, is fixed via a holder to a housing wall of the operating unit and the second thread clamp is also mounted so as to be pivotably movable on the housing wall of the operating unit. A spring element holds the second thread clamp, in this case, abutting the force sensor of the measured value detector.

The force sensor of the measured value detector may, however, as shown in claim 15, also be fixed supported via a damping means on a holder, on which a slide is displaceably guided via a linear guide. The second thread clamp is fixed to the slide and therefore linearly displaceably mounted therewith. A spring element also holds the second thread clamp here abutting the force sensor of the measured value detector. The embodiments described in claim 14 and 15 are distinguished in that oscillations, which may act via the housing wall of the operating unit on the tensile testing device, are damped to such an extent that the measured values are no longer negatively influenced. In other words, the oscillations occurring can be very substantially absorbed by the separate arrangement of the thread clamp and measured value detector and the mounting of the force sensors of the measured value detector in special damping means. A damping means may also be arranged between the thread clamp and the force sensor for further oscillation damping.

It is also provided in an advantageous embodiment, as described in claims 16 to 18, that a thread sensor is arranged in the region of the measuring section. This thread sensor may either be configured as an optical or as a capacitive thread sensor. With such thread sensors known per se, yarn irregularities, in particular yarn mass fluctuations, such as represented, for example, by piecers, can be reliably detected.

A thread sensor of this type allows a piecer which has run with the thread onto the cross-wound bobbin, to be reliably determined and positioned in the region of the measuring section in such a way that it can be tested by means of the tensile testing device. In other words, the piecer positioned inside the measuring section can be subjected at any time to a tear resistance test.

As described in claim 19, it is provided in an advantageous embodiment that the operating unit has its own independent control device, which is connected via a machine bus to the central control unit of the textile machine producing cross-wound bobbins.

The control device of the operating unit, in this case, has an evaluation device, for example, which processes the measuring results of the tensile testing device. A configuration of this type does not only allow operation of the tensile testing device according to the invention or an evaluation of the measuring results either directly via the control device of the operating unit or via the central control unit of the textile machine, but is also as a whole a relatively uncomplicated, economical solution.

As shown in claims 20 to 22, the tensile testing device of the operating device is equipped with a thread catching and draw-in lever, which allows the thread fetched back by the spinning station's own suction nozzle from the cross-wound bobbin to be positioned reliably in the measuring section. In other words, the thread catching and draw-in lever movably arranged on the operating unit is pivoted if necessary into the region of the spinning station and, in the process, a thread catching plate arranged on the thread catching and draw-in lever is positioned in the thread running path in such a way that the thread picked up by the spinning station's own suction nozzle and traversing during unwinding from the cross-wound bobbin can be grasped and placed in the thread clamps of the measuring section. The pivoting of the thread catching and draw-in lever takes place here by means of a stepping motor, an economical spur gear being advantageously connected between the pivot lever and stepping motor.

The invention will be described in more detail below with the aid of an embodiment shown in the drawings, in which:

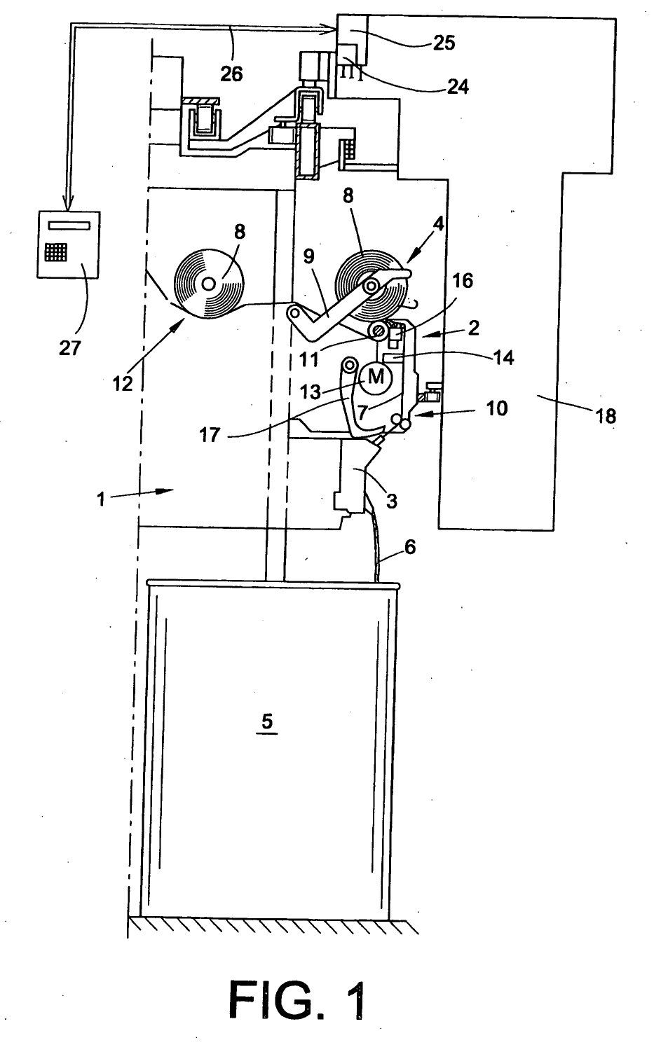

FIG. 1 shows, schematically in a side view, a workstation of a textile machine producing cross-wound bobbins with an operating unit, the tensile testing device equipped according to the invention not being shown here for reasons of clarity,

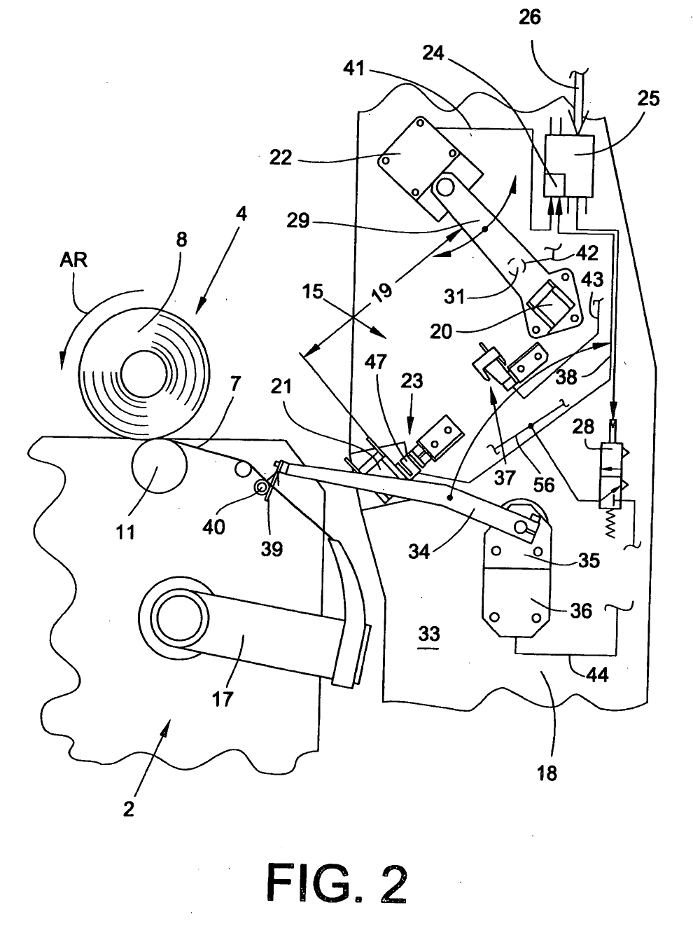

FIG. 2 shows the operating unit with the tensile testing device according to the invention during the thread receiving at a workstation,

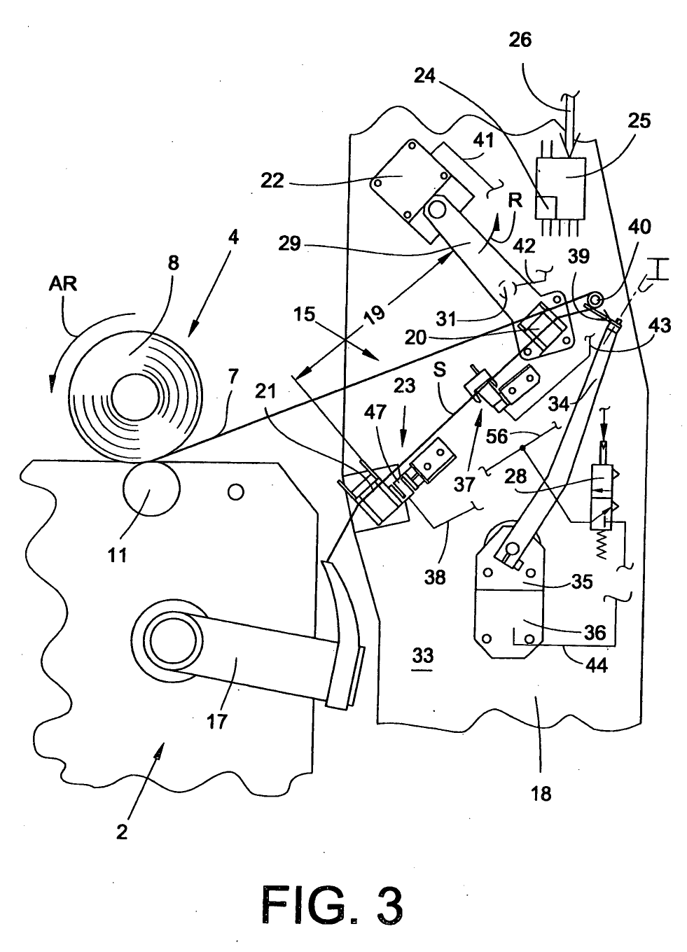

FIG. 3 shows the operating unit according to FIG. 2 when the thread to be checked is placed in the measuring section of the tensile testing device,

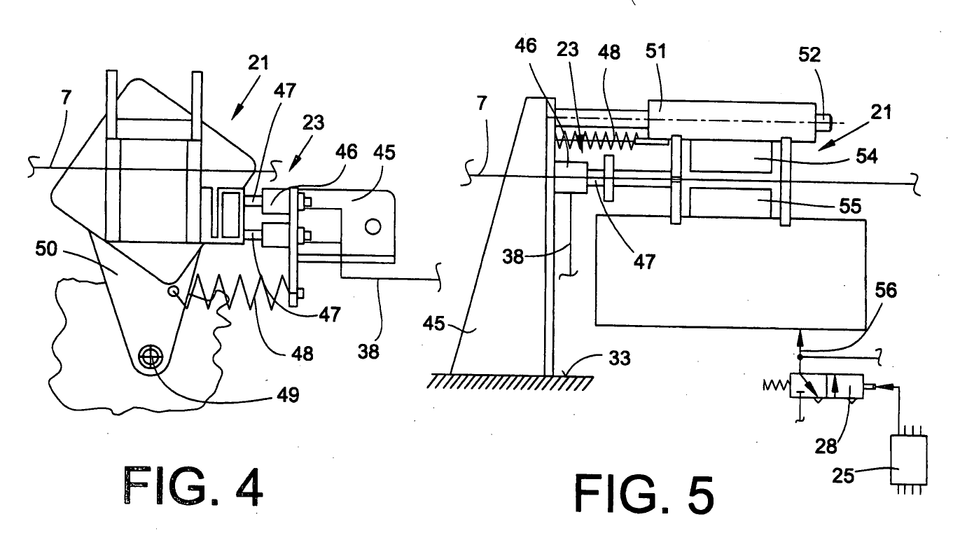

FIG. 4 shows a further embodiment of the arrangement of the second thread clamp and the associated measured value detector,

FIG. 5 shows a third embodiment of the arrangement of the second thread clamp and the associated measured value detector.

FIG. 1 schematically shows in a side view one half of a textile machine 1 producing cross-wound bobbins, an open end rotor spinning machine in the embodiment. Textile machines of this type, as known, between their end frames (not shown) have a plurality of similar workstations 2. These workstations 2 in each case inter alia have a spinning unit 3 and a winding mechanism 4.

The winding mechanism 4, for example, has a creel 9, a bobbin drive roller 11 as well as a thread traversing device 16. The bobbin drive roller 11, which can be acted upon by a drive 13 by means of a single motor, in this case drives the cross-wound bobbin 8 freely rotatably mounted in the creel 9 with frictional engagement.

Fibre bands 6, which are stored in spinning cans 5, are processed in the spinning units 3 to form threads 7, which are then wound onto the winding mechanisms 4 to form cross-wound bobbins 8. The finished cross-wound bobbins are then conveyed via a cross-wound bobbin transporting device 12 to a loading station (not shown) arranged at the end of the machine.

As indicated in FIG. 1, the workstations 2, apart from the spinning unit 3 and the winding mechanism 4, in each case also have further thread handling devices, for example a thread draw-off device 10, a suction nozzle 17 or a waxing device 14. The function of these components is known per se and explained in detail, for example, in DE 101 39 075 A.

Although such workstations 2 work very substantially independently, in other words automatically eliminate spinning interruptions, for example thread breaks, the textile machines are additionally equipped with an operating unit 18, which, apart from the clearing of the textile machine ensures that finished cross-wound bobbins 8 are conveyed onto the cross-wound bobbin transporting device 12 and then new empty tubes are put in exchange into the creels 9. The operating unit 18 has a control device 25, which is connected via a machine bus 26 to the central control unit 27 of the textile machine. Furthermore, the operating unit 18 is equipped with a device according to the invention for testing the quality of the threads produced on the workstations 2 and the piecers.

This device according to the invention designated below a tensile testing device 15 is shown in more detail in FIG. 2 to 5.

As can be seen in particular from FIGS. 2 and 3, the tensile testing device 15 has two thread clamps 20 and 21, which between them form a measuring section 19. The first thread clamp 20 is in this case arranged on a pivot lever 29, which can be pivoted in a defined manner by a stepping motor 22. For the exact positioning of the pivot lever 29 in its zero or starting position, a Hall sensor 31 is preferably also provided. However, instead of the Hall sensor, a fixed stop could also be provided against which the pivot lever rests in its starting position.

Both the stepping motor 22 and the Hall sensor 31 are in this case connected via control lines 41 and 42 to the control device 25 of the operating unit 18.

The second thread clamp 21 is either, as indicated in FIGS. 2 and 3, secured so as to be movable to a limited extent on the housing wall 33 of the operating unit 18 via a measured value detector 23 or, the measured value detector 23 and thread clamp 21 are separately mounted as shown in FIGS. 4 and 5.

The measured value detector 23, preferably a force sensor 47 configured as a strain gauge force detector, is connected via a measured value amplifier and a signal line 38 to the control device 25 of the operating unit 18. An optical or capacitive thread sensor 37, which is also connected via a signal line 43 to the control device 25 of the operating unit 18 is arranged in the region of the measuring section 19, in other words, between the two thread clamps 20 and 21 which can be acted upon pneumatically and which can be controlled together, for example, via an electromagnetic valve 28.

The tensile testing device 15 furthermore has a thread catching and draw-in lever 34, which can be pivoted by means of a stepping motor 36 and a spur gear 35. The stepping motor 36 is also connected via a control line 44 to the control device 25 of the operating unit 18. The thread catching and draw-in lever 34, in the region of its free end, also has a thread catching plate 31 and a deflection pulley 40.

In the embodiment according to FIG. 4, the measured value detector 23 is rigidly connected via a holder 45 to the housing wall 33 of the operating unit 18. The force sensor 47 of the measured value detector 23 is in this case mounted in damping means 46 and connected via a sensor line 38 to the control device 25. The measured value detector 23 corresponds with the second thread clamp 21, which is also mounted on the housing wall 33 of the operating unit 18 so as to be movable to a limited extent about a pivot axis 49. Connected between the thread clamp 21 and the holder 45 of the measured value detector 23 is a spring element 48, which holds the thread clamp 21 abutting the force sensor 47 of the measured value 23.

In the embodiment according to FIG. 5, the thread clamp 21 is linearly displaceably mounted with respect to the housing wall 33 of the operating unit 18. In other words, a holder 45 which is fixed on the housing wall 33 has a linear guide 52, on which a slide 51 is guided so as to slide. The thread clamp 21, which has a pneumatic cylinder 57, the piston rod 55 of which acts on an anvil 54, can be controlled in a defined manner here via an electromagnetic valve 28, by means of a pneumatic line 56. Also fixed on the holder 45, as in the embodiment according to FIG. 4, is a measured value detector 23, the force sensor 47 of which is also cushioned here in a damping means 46, for example a rubber bearing. A spring element 48 also holds the thread clamp 21 abutting the force sensor 47 of the measured value detector 23 in the embodiment according to FIG. 5.

Functioning of the device according to the invention:

The operating unit 18 is ordered to one of the workstations 2 of the textile machine 1 to check the quality of a thread or a piecer if necessary or according to a freely selectable time plan and is then positioned in front of the relevant workstation 2. The thread end of the thread 7 run onto the cross-wound bobbin 8 is then firstly picked up by the spinning station's own suction nozzle 17. The cross-wound bobbin 8 is rotated for this purpose by the bobbin drive roller 11 in the unwinding direction AR and the suction nozzle 17 is acted upon with reduced pressure.

As indicated in FIG. 2, the suction nozzle 17, after picking up the thread end, is pivoted downward and thus forms a thread strand, while the cross-wound bobbin rotates further in the unwinding direction AR. The thread catching and draw-in lever 34 pivots into this thread strand and in the process grasps the traversing thread with its thread catching plate 39. The thread catching and draw-in lever 34 is then pivoted into an insertion position I, as indicated in FIG. 3, the thread being drawn over the pulley 40. During the pivoting of the thread catching and draw-in lever 34, the cross-wound bobbin is rotated further in the unwinding direction AR. In the insertion position I a thread strand 5 has formed between the deflection pulley 40 of the thread catching and draw-in lever 34 and the thread suction nozzle 17, which thread strand is threaded into the opened thread clamps 20, 21 and the optical thread sensor 37.

The further functioning sequence is then directed according to whether a tear resistance test of the thread is to take place or whether a piecer is to be investigated for its tear resistance. If a tear resistance test of the thread is introduced, the thread clamps 20, 21 are pneumatically closed by corresponding control of the electromagnetic valve 28. The thread to be checked is then located in the measuring section 19. During the checking of the tear resistance of the piecer, by means of the suction nozzle 17, further thread is initially unwound from the cross-wound bobbin rotating in the unwinding direction AR, as stated above, and the drawn-off thread is checked by the optical or capacitive thread sensor 37 for a piecer. As soon as the thread sensor 37 detects a piecer of this type, the thread clamps 20, 21 are also pneumatically closed here so the piecer is secured in the region of the measuring section 19.

The pivot lever 29 and therefore the thread clamp 20 are then pivoted by the stepping motor 22 in the direction R until a predetermined prestressing force is registered at the measured value detector 23 via which the thread clamp 21 is fixed to the housing wall 33 of the operating unit 18 so as to be movable to a limited extent. The pivot lever 29 is then moved further in the direction R until there is a thread or spinner break. The motor steps of the stepping motor 22, which the motor carries out from reaching a predeterminable thread prestressing until a maximum tensile force is reached, are counted in the process and are used by multiplication with a suitable conversion formula to calculate the maximum tensile force elongation of the thread 7.

The values measured on the tensile test device 15 according to the invention are certainly comparable with respect to their precision with values, such as could only be achieved up to now in the spinning laboratory.

What is claimed is:

1. Textile machine producing cross-wound bobbins comprising an operating unit and a mechanism for checking the quality of threads or piecings produced on the spinning stations of the textile machine, the operating unit having a tensile testing device and a device for transferring a thread to the tensile testing device, characterized in that the tensile testing device (1 5) has a measuring section (19) of predetermined length with thread clamps (20, 21) arranged at the end of the measuring section (19), in that at least one of the thread clamps (20, 21) is movably mounted and can be acted upon by a drive (22), in that a sensor device (23) for determining the thread tensile force is arranged in the region of the measuring section (19) and in that the drive (22) and the sensor device (23) are connected to a control device (25).

2. Textile machine producing cross-wound bobbins according to claim 1, characterized in that the drive (22) is configured as an electric motor drive, preferably as a stepping motor.

3. Textile machine producing cross-wound bobbins according to claim 1, characterized in that the drive (22) is configured as a pneumatic thrust piston gear.

4. Textile machine producing cross-wound bobbins according to claim 1, characterized in that the sensor device (23) is a measured value detector arranged on one of the thread clamps (20, 21).

5. Textile machine producing cross-wound bobbins according to claim 1, characterized in that the sensor device (23) is thread tensile force sensor arranged between the thread clamps (20, 21).

6. Textile machine producing cross-wound bobbins according to claim 1, characterized in that a first thread clamp (20) is arranged on a pivot lever (29).

7. Textile machine producing cross-wound bobbins according to claim 1, characterized in that a first thread clamp (20) is displaceably guided in a linear guide.

8. Textile machine producing cross-wound bobbins according to claim 6, characterized in that a first thread clamp (20) can be pivoted in a defined manner by the electric motor drive (22) configured as a stepping motor, wherein it is possible to calculate the maximum tensile force elongation of the thread (7) from the number of motor steps, which the stepping motor (22) carries out after reaching a pretensioning force until a maximum tensile force is reached, as well as from a conversion formula.

9. Textile machine producing cross-wound bobbins according to claim 6, characterized in that an initiator (31) is provided to determine the zero position of the pivot lever (29).

10. Textile machine producing cross-wound bobbins according to claim 9, characterized in that the initiator (31) is configured as a Hall sensor (31).

11. Textile machine producing cross-wound bobbins according to claim 6, characterized in that a fixed stop is provided to determine the zero position of the pivot lever (29).

12. Textile machine producing cross-wound bobbins according to claim 1, characterized in that a second thread clamp (21) is fixed via the measured value detector (23) configured as a force sensor on a housing wall (33) of the operating unit (18).

13. Textile machine producing cross-wound bobbins according to claim 1, characterized in that the force sensor is configured as a strain gauge force detector (23) with a measured value amplifier.

14. Textile machine producing cross-wound bobbins according to claim 1, characterized in that the measured value detector (23), the force sensor (47) of which is supported in a damping means (46), is fixed via a holder (45) on a housing wall (33) of the operating unit (18) and in that the second thread clamp (21) is mounted so as to be pivotably movable on the housing wall (33), a spring element (48) being provided which holds the second thread clamp (21) abutting the force sensor (47) of the measured value detector (23).

15. Textile machine producing cross-wound bobbins according to claim 1, characterized in that the measured value detector (23), the force sensor (47) of which is supported in a damping means (46), is fixed to a housing wall (33) of the operating unit (18) via a holder (45), which has a linear guide (52) and in that a slide (51), which carries the second thread clamp (21), is displaceably mounted on the linear guide (52), a spring element (48) being provided, which holds the second thread clamp (21) abutting the force sensor (47) of the measured value detector (23).

16. Textile machine producing cross-wound bobbins according to claim 1, characterized in that a thread sensor (37) is arranged in the region of the measuring section (19) which thread sensor detects the presence of the thread (7).

17. Textile machine producing cross-wound bobbins according to claim 16, characterized in that the thread sensor (37) is configured as an optical thread sensor.

18. Textile machine producing cross-wound bobbins according to claim 16, characterized in that the thread sensor (37) is configured as a capacitive thread sensor.

19. Textile machine producing cross-wound bobbins according to claim 1, characterized in that the control device (25) is part of the operating unit (18) and is connected via a machine bus (26) to a central control unit (27) of the textile machine (1) producing cross-wound bobbins.

20. Textile machine producing cross-wound bobbins according to claim 1, characterized in that the operating unit (18) is equipped with a thread catching and draw-in lever (34), which positions the thread (7) to be checked in the measuring section (19) of the tensile testing device (15).

21. Textile machine producing cross-wound bobbins according to claim 20, characterized in that at least one thread catching plate (39) is arranged at the end of the thread catching and draw-in lever (34).

22. Textile machine producing cross-wound bobbins according to claim 20, characterized in that the thread catching and draw-in lever (34) is connected via a spur gear (35) to a stepping motor (36).
